(19) United States
(12) Patent Application Publication
(10) Pub. No.: US 2024/0374099 A1
(43) Pub. Date: Nov. 14, 2024

(54) MICROPLASTIC COLLECTION DEVICE UTILIZING CYCLONE

(71) Applicant: KOREA INSTITUTE OF OCEAN SCIENCE & TECHNOLOGY, Busan (KR)

(72) Inventors: Young Shik KIM, Daejeon (KR); Hyung Won SHIM, Sejong (KR)

(21) Appl. No.: 18/781,313

(22) Filed: Jul. 23, 2024

Related U.S. Application Data
(63) Continuation of application No. PCT/KR2023/004016, filed on Mar. 27, 2023.

(30) Foreign Application Priority Data
Mar. 29, 2022 (KR) 10-2022-0038984

(51) Int. Cl. A47L 9/16

(52) U.S. Cl. CPC A47L 9/1683; A47L 9/165; A47L 9/1666

(57) ABSTRACT

Proposed is a microplastic collection device utilizing a cyclone The device may include a cylindrical barrel part accommodating a first suction fan and a first suction fan drive at an upper end thereof, and a microplastic suction pipe installed at an interior center of the barrel part to communicate with the first suction fan and configured to suck in microplastics. The device may also include a suction pipe spaced at a predetermined distance from the upper end of the barrel part, coupled to an outer circumferential surface of the barrel part to communicate with an interior of the barrel part, and configured to suck in external particles. The device may further include a microplastic capture pipe coupled to an upper end outer circumferential surface of the barrel part that surrounds the suction pipe. The device can effectively collect microplastics on seashores and separate them from nature.

### CROSS REFERENCE TO RELATED APPLICATION

This application is a continuation application, and claims the benefit under 35 U.S.C. § 120 and § 365 of PCT Application No. PCT/KR2023/004016 filed on Mar. 27, 2023, which claims priority to Korean Patent Application No. 10-2022-0038984 filed on Mar. 29, 2022, each of which are hereby incorporated by reference in their entirety.

### BACKGROUND

### Technical Field

The present disclosure relates to a microplastic collection device, and more particularly, to a microplastic collection device utilizing a cyclone for collecting and picking up microplastics mixed with sand, stones, etc., on a seashore.

### Description of Related Technology

Typically, microplastics (MP) are defined as small plastic particles of 5 mm or less. Plastics that have been made smaller than or equal to 5 mm from the time of production (commonly referred to as primary microplastics), as well as plastics that have been artificially or naturally worn down to 5 mm or less (commonly referred to as secondary microplastics) fall into microplastics.

### SUMMARY

One aspect is a microplastic collection device utilizing a cyclone that can effectively collect microplastics on seashores and separate them from nature.

Another aspect is to make it possible to carry out the task of collecting and picking up microplastics more easily by providing a microplastic collection device utilizing a cyclone that can be conveniently carried by workers.

The aspects of the present disclosure are not limited to those mentioned above, and other aspects that have not been mentioned will be clearly understood by those skilled in the art from the description below.

Another aspect is a microplastic collection device utilizing a cyclone, that includes a cylindrical barrel part on which a first suction fan and a first suction fan drive part are installed at an upper end thereof, a microplastic suction pipe installed at an interior center of the barrel part to communicate with the first suction fan and configured to suck in microplastics, a suction pipe spaced at a predetermined distance from the upper end of the barrel part, coupled to an outer circumferential surface of the barrel part to communicate with an interior of the barrel part, and configured to suck in external particles, and a microplastic capture pipe coupled to an upper end outer circumferential surface of the barrel part that surrounds the suction pipe.

In addition, a lower portion of the barrel part of the microplastic collection device utilizing a cyclone in accordance with one preferred embodiment of the present disclosure is formed in a shape in which a diameter gradually decreases downward, and a discharge pipe opened in a predetermined diameter is coupled to the lower end of the barrel part.

Further, the microplastic capture pipe of the microplastic collection device utilizing a cyclone in accordance with one preferred embodiment of the present disclosure further includes a reticulate microplastic capture part coupled to an outer end and configured to receive fluid from an interior of the microplastic capture pipe and particles contained in the fluid, and a microplastic capture filter that is surrounded by the microplastic capture part and in which through-holes with a size of a predetermined range are formed.

Moreover, the suction pipe of the microplastic collection device utilizing a cyclone in accordance with one preferred embodiment of the present disclosure has a second suction fan and a second suction fan drive part coupled to an outer end and installed near one end coupled to the suction pipe, and further includes at the other end thereof a distal suction pipe in communication with the second suction fan and configured to suck in external particles.

Furthermore, the suction pipe of the microplastic collection device utilizing a cyclone in accordance with one preferred embodiment of the present disclosure has a second suction fan and a second suction fan drive part coupled to an outer end and installed near one end coupled to the suction pipe, and further includes at the other end thereof a distal suction pipe in communication with the second suction fan and configured to suck in external particles, and a bending suction pipe, which is made of a soft or elastic material and is bendable, is coupled between the suction pipe and the distal suction pipe.

According to one embodiment of the present disclosure, there is an effect of being able to provide a microplastic collection device utilizing a cyclone that can effectively collect microplastics on seashores and separate them from nature.

According to one embodiment of the present disclosure, there is an effect of making it possible to carry out the task of collecting and picking up microplastics more easily by providing a microplastic collection device utilizing a cyclone that can be conveniently carried by workers.

The effects of the present disclosure are not limited to those mentioned above, and other effects that have not been mentioned will be clearly understood by those skilled in the art from the description of the claims.

### BRIEF DESCRIPTION OF THE DRAWINGS

FIG. 1 is a view conceptually illustrating a state in which a worker carries out a task of collecting microplastics on a seashore by using a microplastic collection device utilizing a cyclone in accordance with one preferred embodiment of the present disclosure.

FIG. 2 is a conceptual cross-sectional view for describing the structure of a microplastic collection device utilizing a cyclone, and a cyclone formed inside the device during operation, in accordance with one preferred embodiment of the present disclosure.

FIG. 3 shows flow velocity distribution diagrams showing, respectively, the flow velocity for each part inside the device according to shapes when a general shape and a conical shape are respectively applied to a barrel part of a microplastic collection device utilizing a cyclone in accordance with one preferred embodiment of the present disclosure.

### DETAILED DESCRIPTION

Microplastic beads contained in plastic waste discarded on land and finely worn, in toothpaste, cosmetics, or the like are freely flowing into the sea. Further, microplastics that have flowed into the sea can come into contact with harmful chemicals in the sea and turn into highly concentrated toxic substances. The microplastics that have flowed into the sea and turned into toxic substances in this way are mistaken for food by plankton and ingested, then move to organisms along the food chain, accumulating toxicity, and are eventually consumed by humans.

Looking into examples of microplastic ingestion by animals living on seashores as described above, it has been documented that birds and turtles in particular ingest plastics extensively, and for species that ingest plastics among marine birds, only the species that have been confirmed to ingest plastics, such as the black-footed albatross (Phoebastria nigripes), which feeds plastic chunks to its young, reach at least 44%.

Moreover, microplastics have the ability to adsorb, release, and transport toxic substances such as persistent organic pollutants (POPs), have been reported to be ingested by both vertebrates and invertebrates, and are highly likely to be causing bioaccumulation. Therefore, the management of marine plastic waste is urgent.

Meanwhile, large amounts of plastic waste are dumped on seashores, and common large-sized plastic waste can be easily collected, but microplastics, which are more detrimental to the environment, are difficult to collect because they are hardly visible and are mixed with sand.

Furthermore, according to the results derived from the domestic coastal trash monitoring project in Korea, plastics, including Styrofoam, accounted for 60% or more of domestic coastal trash in 2018, and plastic marine trash accounted for 85% of the total amount of marine trash, excluding wood, which was temporary natural disaster trash caused by rainy seasons, floods, and the like.

This is because Styrofoam buoys are widely used in aquaculture on the seashores of Korea. In particular, Styrofoam buoys are broken into small pieces and large amounts of microplastics are continuously supplied to the seashores, causing an increase in the concentration of microplastics on beach, in regions with many aquaculture farms. As the microplastics that have flowed into beaches as described above are made up of small grains, the national and local governments have difficulty in carrying out direct collection, resulting in an urgent need to prepare countermeasures.

In addition, because plankton gathers in large quantities in areas adjacent to seashores, there is a need for technology to effectively remove microplastics that are widely distributed along seashores.

Although there are a variety of types of equipment for collecting coastal waste that have already been proposed, it has been difficult to apply large appliances or equipment due to the nature of seashores, which is rich in sand. Further, it has not been easy to separate microplastics from the sand on seashores.

In particular, despite the serious level of microplastic pollution in Korea, it is hard to find organizations/enterprises that present specific measures for collecting microplastics accumulated on beaches.

Hereinafter, preferred embodiments of the present disclosure will be described in detail as follows with reference to the accompanying drawings to the extent that those skilled in the art to which the present disclosure pertains can readily practice the present disclosure.

In describing the embodiments, descriptions of technical details that are well known in the technical field to which the present disclosure pertains and that are not directly related to the present disclosure will be omitted. This is to convey the subject matter of the present disclosure more clearly without obscuring it by omitting unnecessary descriptions.

For the same reason, some components are exaggerated, omitted, or shown schematically in the accompanying drawings. Further, the size of each component does not entirely reflect its actual size. The same or corresponding components in each drawing are assigned the same reference numerals.

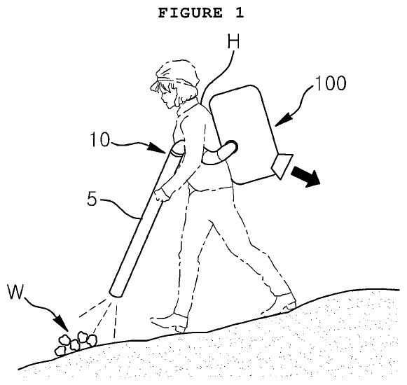

FIG. 1 is a view conceptually illustrating a state in which a worker carries out a task of collecting microplastics on a seashore by using a microplastic collection device utilizing a cyclone in accordance with one preferred embodiment of the present disclosure.

Referring to FIG. 1, a worker H is sucking mixed trash W on the ground into the interior of a microplastic collection device utilizing a cyclone 100 by using a bending suction part 10 and a distal suction pipe 5 while moving with the microplastic collection device utilizing a cyclone 100 held on his/her back.

As shown in FIG. 1, most of the places where the activities of collecting microplastics take place are likely to be seashores.

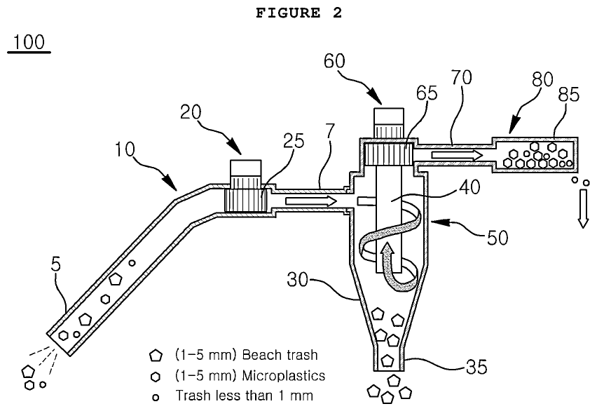

FIG. 2 is a conceptual cross-sectional view for describing the structure of a microplastic collection device utilizing a cyclone, and a cyclone formed inside the device during operation, in accordance with one preferred embodiment of the present disclosure.

Referring to FIG. 2, the microplastic collection device utilizing a cyclone 100 is characterized by including a cylindrical barrel part 50 on which a first suction fan 65 and a first suction fan drive part 60 are installed at an upper end thereof, a microplastic suction pipe 40 installed at an interior center of the barrel part 50 to communicate with the first suction fan 65 and configured to suck in microplastics, a suction pipe 7 spaced at a predetermined distance from the upper end of the barrel part 50, coupled to an outer circumferential surface of the barrel part 50 to communicate with the interior of the barrel part 50, and configured to suck in external particles, and a microplastic capture pipe 70 coupled to an upper end outer circumferential surface of the barrel part 10 that surrounds the suction pipe 7.

The microplastic collection device utilizing a cyclone 100 of the present disclosure is implemented to include the basic form as described above, and selects and collects microplastics out of the mixed trash W drawn into the interior of the barrel part 50 via the suction pipe 7.

In order to suck in the mixed trash W from the outside and draw it into the interior of the barrel part 50, a cyclone airflow is formed inside the barrel part 50 by using the first suction fan 65 and the first suction fan drive part 60 for sucking in external particles near the upper end of the barrel part, the suction pipe 7 with a predetermined diameter is installed so that external particles can be sucked and drawn into the interior of the barrel part 50, and the mixed trash W sucked into the interior of the barrel part 50 is drawn into the interior of the barrel part 50 and then is caused to make a circular motion along the inner surface of the barrel part 50 by the cyclone airflow.

Thereafter, relatively heavy particles of the mixed trash W that make a circular motion along the inner surface of the barrel part 50 by the cyclone airflow move downward along an inclined surface of an inclined barrel 30, which is formed at the lower portion of the barrel part 50 in a shape in which the diameter gradually decreases downward, pass through a barrel discharge pipe 35 opened in a predetermined diameter, and are discharged to the outside of the microplastic collection device utilizing a cyclone 100 and the barrel part 50.

Here, by further installing stoppers capable of opening and closing the barrel discharge pipe 35 as needed at both ends or at any one point of the barrel discharge pipe 35 and opening and closing them as needed, it is also possible to configure to discharge the heavy particles, which are supposed to be discharged automatically a short time after the mixed trash W has flowed in, at a desired time.

Further, the light particles contained in the mixed trash W that make a circular motion along the inner surface of the barrel part 50 by the cyclone airflow formed inside the barrel part 50, and the microplastics contained in the light particles flow into the microplastic suction pipe 40 through which a part of the airflow formed by the first suction fan 65 passes and that is installed at the interior center of the barrel part 50, and gathers in the microplastic capture pipe 70.

In addition, a reticulate microplastic capture part 80 that receives fluid from the interior of the microplastic capture pipe 70 and particles contained in the fluid is coupled to an outer end of the microplastic capture pipe 70, and a microplastic capture filter 85 in which through-holes with a size of a predetermined range are formed is installed so as to be surrounded by the microplastic capture part 80.

By configuring the microplastic capture part 80 in this way, it may be practiced such that the microplastics contained in the mixed trash W are collected in the microplastic capture part 80, and at the same time, particulate trash having a size smaller than the through-holes on the surface of the microplastic capture filter 85 is discharged to the outside of the microplastic capture part 80 and the microplastic collection device utilizing a cyclone 100.

Further, by configuring the microplastic capture part 80 to be easily detachable, when the microplastics collected in the microplastic capture part 80 reach a certain level, the microplastic capture part 80 can be replaced immediately with a spare empty microplastic capture part 80 and the microplastic collection work can continue.

In addition, it may not be easy to suck in external mixed trash W on the ground of a seashore with only the suction pipe 7 spaced and installed at a predetermined distance from the upper end of the outer circumferential surface of the barrel part 50.

To resolve this issue, the distal suction pipe 5 that extends the suction pipe 7 outward is coupled to the outer end of the suction pipe 7.

Further, a second suction fan 25 and a second suction fan drive part 20 may be installed near one end of the distal suction pipe 5 coupled to the suction pipe 7 and reinforce the ability to generate airflow for sucking in the external mixed trash W.

In addition, by installing a bending suction pipe 10, which is made of a soft or elastic material and is bendable, between the suction pipe 7 and the distal suction pipe 5, it may be configured such that the distal suction pipe 5 can be more easily moved to a desired position by the worker H.

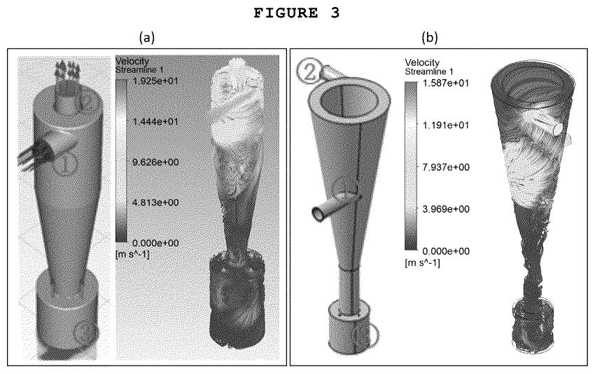

Moreover, an improved shape of the barrel part 50 for reducing the energy consumed by the microplastic collection device utilizing a cyclone of the present disclosure is shown in FIG. 3.

FIG. 3 shows flow velocity distribution diagrams showing, respectively, the flow velocity for each part inside the device according to shapes when a general shape and a conical shape are respectively applied to a barrel part of a microplastic collection device utilizing a cyclone in accordance with one preferred embodiment of the present disclosure.

(a) of FIG. 3 is an external view and a flow velocity distribution diagram inside the device when the shape of the barrel part 50 is a combination of a cylinder and a cone, as with a commonly used cyclone device, and (b) of FIG. 3 is an external view and a flow velocity distribution diagram inside the device when the shape of the barrel part 50 is a conical shape in accordance with the present disclosure. The symbols \textcircled{1}, \textcircled{2}, and \textcircled{3}included in (a) and (b) of FIG. 3 refer to the suction pipe 7 (\textcircled{1}), the microplastic capture pipe 70 (\textcircled{2}), and the barrel discharge pipe 35 (\textcircled{3}), respectively.

Here, the simulation results show that the microplastic capture rate is 92.78% when \textcircled{2}outlet suction is at 12.5 m/s in the case where the barrel part 50 has a general cyclone shape as shown in (a) of FIG. 3, and the microplastic capture rate is 91.77% when (\textcircled{2}) outlet suction is at 9.5 m/s in the case where the barrel part 50 has a cone shape as shown in (b) of FIG. 3, and the level of energy consumption differs by tens of percent according to the difference in suction speed, whereas the microplastic capture rate differs by only a small amount of merely 1%, and thus, it can be seen that a substantial reduction in energy consumption is realized when the conical barrel part 50 as shown in (b) of FIG. 3 is adopted.

The places where activities of collecting and picking up microplastics are carried out using the microplastic collection device utilizing a cyclone 100 in accordance with one preferred embodiment of the present disclosure as described above are mostly seashores, and the mixed trash W is mainly beach trash including particulate natural materials such as stones and sand and microplastics, which are smaller than or equal to 5 mm. Trash on seashores may contain some water.

Here, the size of the objects contained in the mixed trash W to be sucked into the interior of the collection device via the distal suction pipe 5 is not necessarily limited to objects of 5 mm or less.

It should be noted that the suction capacity can be changed by adjusting the intensity of the cyclone airflow by the first/second suction fan and the first/second suction fan drive part, and thus, it can be practiced by adjusting it to an appropriate level according to the implementation conditions and environment.

In addition, since the first suction fan 65/suction fan drive part 60 installed in the barrel part 50 and the second suction fan 25/suction fan drive part 20 installed at one end of the distal suction pipe 5 may be installed simultaneously or may be implemented by selecting only one them depending on the embodiment, they can be implemented by selectively installing as appropriate according to the suction capacity required in the embodiment.

In other words, it can be implemented in the form of installing only the first suction fan 65 and the first suction fan drive part 60 in an embodiment where the suction capacity for the mixed trash W is expected to be sufficient with only the first suction fan 65/suction fan drive part 60, it can be implemented in the corresponding form if the second suction fan 25 and the second suction fan drive part 20 are sufficient, and it can be implemented in the form of including both of them in an embodiment where sufficient suction capacity is expected to be achieved only if both the first/second suction fans 65/25 and the first/second suction fan drive parts 60/20 are installed.

While the present specification and drawings disclose the preferred embodiments of the present disclosure and certain terms are used, these are merely used in a general sense to easily describe the technical details of the present disclosure and to facilitate understanding of the disclosure, and are not intended to limit the scope of the present disclosure. It is obvious to those skilled in the art to which the present disclosure pertains that in addition to the embodiments disclosed herein, other modifications based on the technical idea of the present disclosure can be implemented.

What is claimed is:

1. A microplastic collection device utilizing a cyclone, comprising:
a cylindrical barrel part accommodating a first suction fan and a first suction fan drive part at an upper end thereof;
a microplastic suction pipe installed at an interior center of the barrel part to communicate with the first suction fan and configured to suck in microplastics;
a suction pipe spaced at a predetermined distance from the upper end of the barrel part, coupled to an outer circumferential surface of the barrel part to communicate with an interior of the barrel part, and configured to suck in external particles; and
a microplastic capture pipe coupled to an upper end outer circumferential surface of the barrel part that surrounds the suction pipe,
wherein the external particles are configured to be sucked into the barrel part along with air, and then separated into relatively heavy particles and light particles by centrifugal force as the external particles rotate along an inner surface of the barrel part,
wherein the light particles are configured to be sucked into the microplastic suction pipe and gather in the microplastic capture pipe, and
wherein the heavy particles are configured to gather at a lower end of the barrel part.

2. The microplastic collection device utilizing a cyclone of claim 1, wherein a lower portion of the barrel part is formed in a shape in which a diameter gradually decreases downward, and wherein a discharge pipe opened in a predetermined diameter is coupled to the lower end of the barrel part.

3. The microplastic collection device utilizing a cyclone of claim 1, wherein the microplastic capture pipe further comprises:
a reticulate microplastic capture part coupled to an outer end and configured to receive fluid from an interior of the microplastic capture pipe and particles contained in the fluid; and
a microplastic capture filter surrounded by the microplastic capture part and comprising through-holes with a size of a predetermined range.

4. The microplastic collection device utilizing a cyclone of claim 1, wherein the suction pipe comprises:
a second suction fan and a second suction fan drive part coupled to an outer end and installed near one end coupled to the suction pipe, and
at the other end thereof a distal suction pipe in communication with the second suction fan and configured to suck in external particles.

5. The microplastic collection device utilizing a cyclone of claim 1, wherein the suction pipe comprises:
a second suction fan and a second suction fan drive part coupled to an outer end and installed near one end coupled to the suction pipe, and
at the other end thereof a distal suction pipe in communication with the second suction fan and configured to suck in external particles, and
wherein a bending suction pipe, made of a soft or elastic material and bendable, is coupled between the suction pipe and the distal suction pipe.
